(19) United States
(12) Patent Application Publication
(10) Pub. No.: US 2022/0142044 A1
(43) Pub. Date: May 12, 2022

(54) Mower Support Apparatus

(71) Applicant: Ronald Robinson, Muscadine, AL (US)

(72) Inventor: Ronald Robinson, Muscadine, AL (US)

(21) Appl. No.: 17/095,275

(22) Filed: Nov. 11, 2020

(51) Int. Cl. A01D 34/00

(52) U.S. Cl. CPC A01D 34/001

(57) ABSTRACT

A support apparatus adapted for use with a riding lawnmower. The support apparatus is configured to assist a user in mounting, dismounting, and provide stability while operating the riding lawnmower. The support apparatus comprises a pair of ergonomically shaped support legs and a crossbar member connecting the pair of support legs at one end of each of the support legs. Each of the pair of support legs is attachable to a platform of the riding lawnmower via a mounting plate. Each mounting plate is perpendicularly attached to an opposite end of the respective support leg as the crossbar member.

### BACKGROUND

The present invention generally relates to support apparatus for use with a riding lawnmower, and more specifically to a support apparatus for assisting a user in mounting, dismounting, and operating a riding lawnmower. Accordingly, the present specification makes specific reference thereto. However, it is to be appreciated that aspects of the present invention are also equally amenable to other like applications, devices and methods of manufacture.

Operating a riding or zero-turn lawnmower can be a difficult and frustrating experience. This difficulty is compounded when the user is physically limited, disabled, or elderly. Simply mounting and dismounting the riding lawnmower can be problematic and lead to unsteady balance. People may accidently slip and fall while attempting to get on or off of the lawnmower leading to serious injury. If the lawnmower is on and the blades are engaged while attempting to mount or dismount, the resulting injuries may be catastrophic.

Mowing the lawn is a recurring frequent task. The elderly and physically disabled often have more free time and enjoy the outdoors. Mowing the lawn can be a rewarding experience allowing the individual to participate in useful tasks while getting some exercise. However, these individuals tend to have less endurance and often have significant mobility issues. Cutting a lawn with a riding lawn mower can be a hard task and even dangerous for the average person. Not being able to perform this task because they cannot easily and safely get on and off the mower can by psychologically detrimental to these individuals. Providing a safe and effective way to overcome this problem can make these individuals feel needed and useful. Additionally, they do not have to rely on family members or pay someone to perform this task.

A riding mower or zero-turn lawn mower is a powerful machine that is generally operated by a seated rider. The step up onto the mower deck can be awkward to traverse as the user typically mounts from the side or front while simultaneously stepping up onto the mower deck and twisting onto the seat. This requires some degree of flexibility, balance, and strength. Riding lawnmowers are not generally designed with extra points of contact intended to assist users in mounting and dismounting the machine. They are also not designed with balance components to assist an operator keep their balance while engaged in mowing operations.

In this manner, the improved support apparatus of the present invention accomplishes all of the forgoing objectives, thereby providing an easy solution to safely mount, dismount, and operate a riding lawnmower. The apparatus prevents stumbles and falls while getting on or off of the mower. The invention is a helpful tool for the elderly or physically limited to maneuver themselves onto a riding mower. This leads to improved personal safety and peace of mind while maintaining the lawn.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some concepts in a simplified form as a prelude to the more detailed description that is presented later.

The subject matter disclosed and claimed herein, in one embodiment thereof, comprises a support apparatus. The support apparatus is configured mount to a riding lawnmower to provide stability when mounting, dismounting, or operating the riding lawnmower. The support apparatus comprises a pair of support leg members, a crossbar member, and a pair of mounting plates. Each of the support leg members comprises a vertical portion and an angled portion extending from the vertical portion. The angled portion extends from the vertical portion at a bend. Each vertical portion comprises a mounting plate end and an angle portion end. Each angled portion comprises a vertical portion end and a crossbar member end. Each support leg member may further comprise at least one support leg member gripping element.

The crossbar member comprises a pair of ends. The crossbar member connects the pair of support leg members from one end of each of the support leg members by the pair of ends of the crossbar member. Each of the pair of ends of the crossbar member connects or extends into the crossbar member end of the respective angled portion of the respective support leg member. Both support leg members and the crossbar member may be formed out of a single piece of tubular material. The crossbar member may further comprise a gripping element.

Each mounting plate comprises a support leg member connection. Each mounting plate may further comprise a pair of mounting holes. Each mounting plate is attached to the respective support leg member at an opposing end of the respective support leg member as the crossbar member. The vertical portion of the respective support leg member is attached to and extends substantially perpendicularly from the respective mounting plate. Each of the mounting plates is attachable to a mower platform of the riding lawnmower.

In an additional embodiment, the subject matter disclosed and claimed herein comprises a support apparatus. The support apparatus is configured mount to a riding lawnmower to provide stability when mounting, dismounting, or operating the riding lawn mower. The support apparatus comprises a pair of support leg members, a crossbar member, and a pair of mounting plates. Each of the support leg members comprise a vertical portion and an angled portion connected to the vertical portion.

The angled portion connects to the vertical portion by an articulating joint. The articulating joint allows the angled portion to adjust in angle with respect to the vertical portion. Each vertical portion comprises a mounting plate end and an angle portion end. Each vertical portion may further comprise a telescoping portion for adjusting a length of each support leg member. Each angled portion comprises a vertical portion end and a crossbar member end. Each support leg member may further comprise at least one support leg member gripping element.

The crossbar member comprises a pair of ends. The crossbar member connects the pair of support leg members from one end of each of the support leg members by the pair of ends of the crossbar member. Each of the pair of ends of the crossbar member connects or extends into the crossbar member end of the respective angled portion of the respective support leg member. Both support leg members and the crossbar member may be formed out of a single piece of tubular material. The crossbar member may further comprise a gripping element.

Each mounting plate comprises a support leg member connection. The support leg member connection may comprise a mounting plate articulating joint. The vertical portion of the respective support leg member is movably attached to the respective mounting plate via the mounting plate articulating joint. The mounting plate articulating joint allows the vertical portion of the respective support leg member to adjust in angle with respect to the mounting plate. Each mounting plate may further comprise a pair of mounting holes. Each mounting plate is attached to the respective support leg member at an opposing end of the respective support leg member. Each of the mounting plates is attachable to a mower platform of the riding lawnmower.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and is intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one embodiment of a support apparatus of the present invention for use with a riding lawn mower in accordance with the disclosed architecture.

FIG. 2 illustrates a perspective view of the support apparatus of the present invention installed on a riding lawnmower in accordance with the disclosed architecture.

FIG. 3 illustrates a side view of the support apparatus of the present invention installed on the riding lawnmower in accordance with the disclosed architecture.

FIG. 4 illustrates a front view of the support apparatus of the present invention installed on the riding lawnmower in accordance with the disclosed architecture.

FIG. 5 illustrates a perspective view of the support apparatus of the present invention for use with the riding lawn mower in accordance with the disclosed architecture.

FIG. 6 illustrates a cutaway view of one of a pair of mounting plates of the support apparatus of the present invention for use with the riding lawnmower in accordance with the disclosed architecture.

FIG. 7 illustrates a perspective view of another embodiment of a support apparatus of the present invention for use with a riding lawn mower in accordance with the disclosed architecture.

FIG. 8 illustrates a cutaway view of one of a pair of mounting plates of the support apparatus of the present invention for use with the riding lawnmower in accordance with the disclosed architecture.

FIG. 9 illustrates a cutaway view of one of a pair of support leg members of the support apparatus of the present invention for use with the riding lawnmower in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They do not intend as an exhaustive description of the invention or do not limit the scope of the invention. Additionally, an illustrated embodiment need not have all the aspects or advantages shown. Thus, in other embodiments, any of the features described herein from different embodiments may be combined.

The present invention provides users with a support bar for zero-turn lawnmowers to assist in mounting and dismounting. The support structure provides a stable gripping surface to help hoist the user up onto the mower or assist in getting off the mower. The bar features two support legs and a handle section for convenient gripping while getting on or off the mower. The support apparatus may also be used for stability while operating the mower. The support legs may be bolted to the platform section of the mower. The support apparatus provides additional stability and balance for people facing physical and/or strength challenges. The apparatus provides additional points of contact when climbing on and off a mower or moving from a sitting to a standing position.

The support apparatus is mountable on the foot plate of the zero-tum lawn mower and is secured by mechanical fasteners. Users can install the support apparatus on the rising lawnmower and then grab a plurality of points of contact on the apparatus for support. The handle or crossbar in one embodiment may be approximately between 2$ and 36 inches in length. The handle or crossbar is easily graspable to assist the operator in getting on and off of the riding lawnmower offering a smooth transition for the operator.

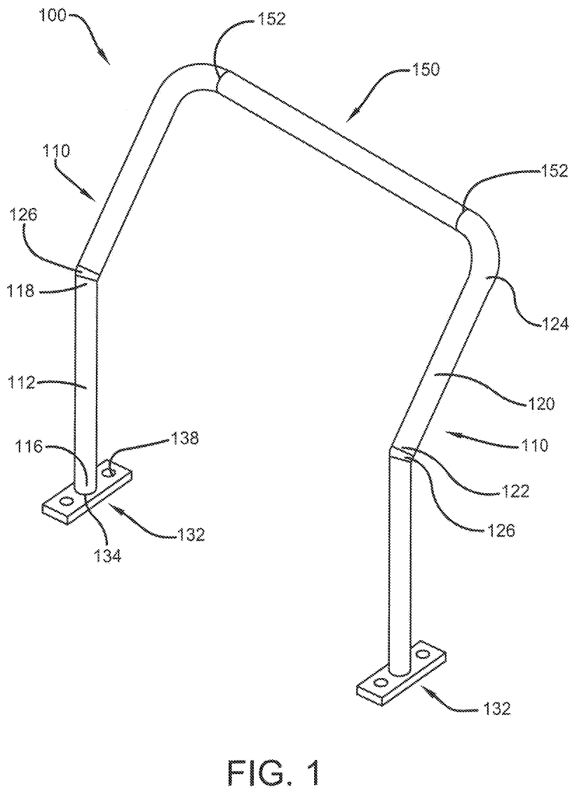

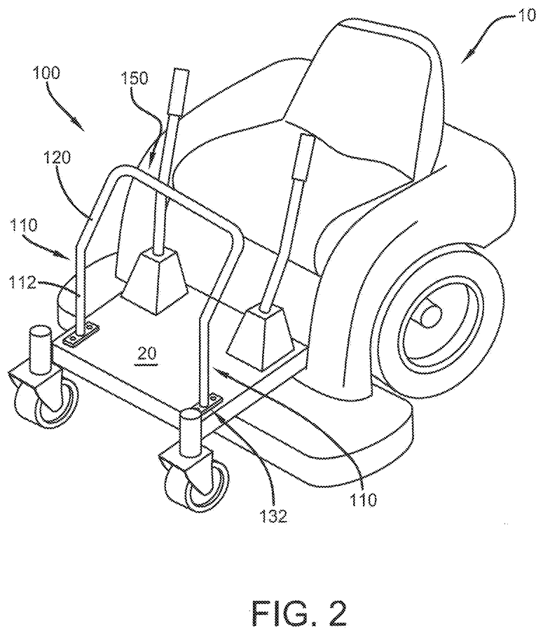

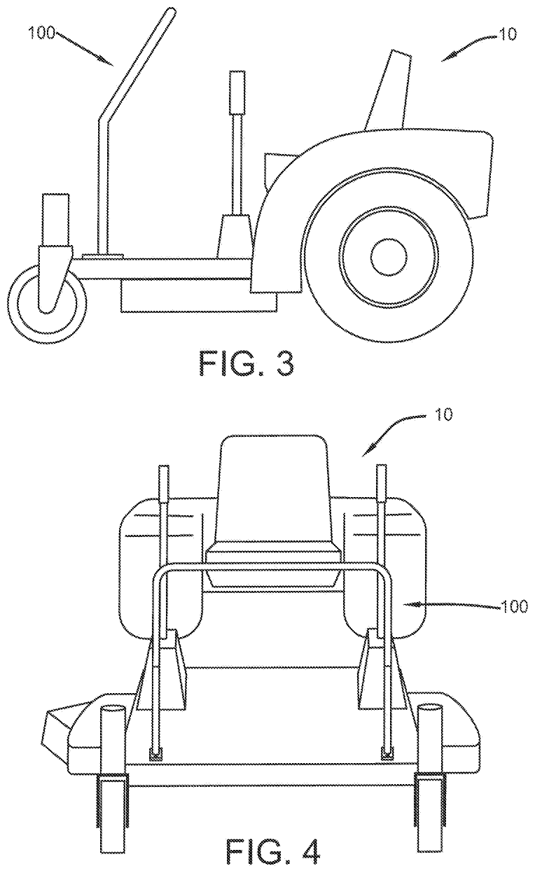

Referring initially to the drawings, FIGS. 1-9 illustrate a support apparatus 100 for use with a riding lawnmower 10. The support apparatus 100 is configured mount to a mower platform 20 of the riding lawnmower 10 to provide stability for a user when mounting, dismounting, or operating the riding lawnmower 10 as illustrated in FIGS. 2-4. The support apparatus 100 comprises a pair of support leg members 110, a crossbar member 150, and a pair of mounting plates 132. The support leg members 110 and the crossbar member 150 may be manufactured from tubular or solid metal or plastic.

As illustrated in FIG. 1, each of the support leg members 110 comprise a vertical portion 112 and an angled portion 120 extending from the vertical portion 112. The angled portion 112 extends from the vertical portion 120 at a bend 126. Each vertical portion 112 comprises a mounting plate end 116 and an angle portion end 118. Each angled portion 120 comprises a vertical portion end 122 and a crossbar member end 124. The bend 126 may be formed into each support leg member via a press brake, roller, or any other common metal bending process. Alternatively, the bend 126 may be a weld where the vertical portion end 122 of the angled portion 120 meets the angle portion end 118 of the vertical portion 112.

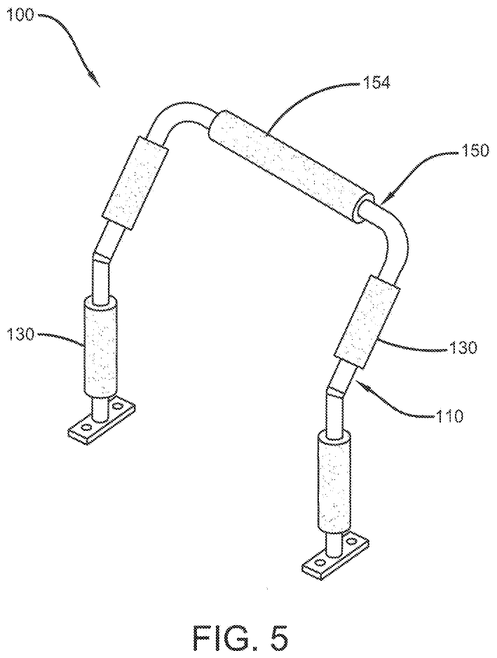

As illustrated in FIG. 5, each support leg member 110 may further comprise at least one support leg member gripping element 130. Each support leg member gripping element 130 may be a padded roll or similar material that surrounds and cushions at least a portion of the respective support leg member 110. Alternatively, each support leg member gripping element 130 could be a molded rubber or plastic hand grip disposed around or along at least a portion of the respective support leg member 110. Each support leg member gripping element 130 may be positioned and configured to provide a better point of contact for grasping the support apparatus 100 while mounting, dismounting, or operating the riding lawnmower 10.

Returning to FIG. 1, the crossbar member 150 comprises a pair of ends 152. The crossbar member 150 connects the pair of support leg members 110 at one end 124 of each of the support leg members 110 by the pair of ends of the crossbar member 152. Each of the pair of ends 152 of the crossbar member 150 connects or extends into the crossbar member end 124 of the angled portion 120 of the respective support leg member 110. Both support leg members 110 and the crossbar member 150 may be formed out of a single piece of material. As illustrated in FIG. 5, the crossbar member 150 may further comprise a crossbar gripping element 154 similar in construction and configuration as the at least one support leg member gripping element 130. The crossbar gripping element 154 may be a padded roll or molded rubber or plastic hand grip disposed around or along the crossbar member 150.

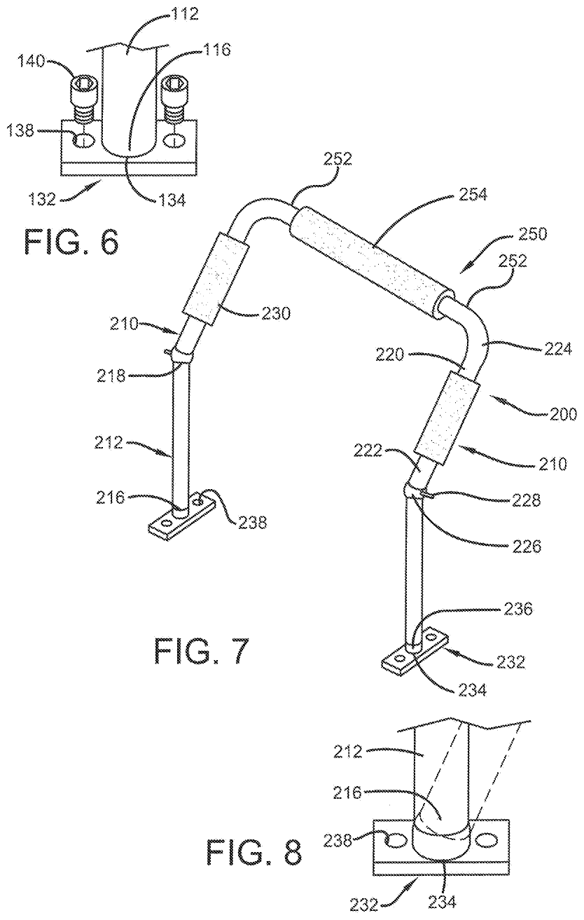

As illustrated in FIGS. 1 and 6, each mounting plate 132 comprises a support leg member connection 134. Each mounting plate 132 may further comprise a pair of mounting holes 138. Each mounting plate 132 is attached to the respective support leg member 110 at an opposing end 116 of the respective support leg member 110. The vertical portion 112 of the respective support leg member 110 is attached to and extends substantially perpendicularly from the respective mounting plate 132, so that the respective support leg member 110 extends substantially perpendicularly from the respective mounting plate 132. Each of the mounting plates 132 is attachable to a mower platform 20 of the riding lawnmower 10. Each of the mounting plates 132 is attachable via a plurality of mechanical fasteners 140, such as bolts, rivets, screws, or the like engaging the pair of mounting holes 238, or by welds.

FIGS. 7-9 illustrate an additional embodiment of a support apparatus 200 for use with a riding lawn mower 10. The support apparatus 200 is also configured mount to a mower platform 20 of the riding lawnmower 10 to provide stability when mounting, dismounting, or operating the riding lawnmower 10 as illustrated in FIGS. 2-4. The support apparatus 200 comprises a pair of support leg members 210, a crossbar member 250, and a pair of mounting plates 232.

As illustrated in FIG. 7, each of the support leg members 210 comprise a vertical portion 212 and an angled portion 220 extending from the vertical portion 212. The angled portion 212 extends from the vertical portion 220 at an articulating joint 226. The articulating joint 226 allows the angled portion 220 to adjust in angle with respect to the vertical portion 212. Once the angle is adjusted, a securing element 228, such as a pin, screw, rod, or the like, may engage the articulating joint 226 to keep it fixed in position. Each vertical portion 212 comprises a mounting plate end 216 and an angle portion end 218.

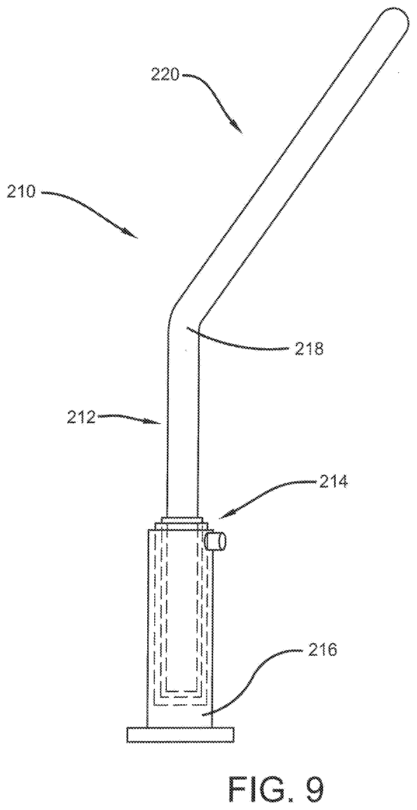

As illustrated in FIG. 9, each vertical portion 212 may further comprise a telescoping portion 214 for adjusting a length of each support leg member 212. The telescoping section 214 allows the vertical portion 212 to extend or retract in length based on the needs of the user. Once the proper length is selected, the telescoping section 214 may be secured to the rest of the vertical portion 212 with a securing element, such as a pin, screw, rod, or the like, to fix the length.

As illustrated in FIG. 7, each support leg member 210 may further comprise at least one support leg member gripping element 230. Each support leg member gripping element 230 may be a padded roll or similar material that surrounds and cushions at least a portion of the respective support leg member 210. Alternatively, each support leg member gripping element 230 could be a molded rubber or plastic hand grip disposed around or along at least a portion of the respective support leg member 210. Each support leg member gripping element 230 may be positioned and configured to provide a better point of contact for grasping the support apparatus 200 while mounting, dismounting, or operating the riding lawnmower 10.

The crossbar member 250 comprises a pair of ends 252. The crossbar member 250 connects the pair of support leg members 210 at one end 224 of each of the support leg members 210 by the pair of ends of the crossbar member 252. Each of the pair of ends 252 of the crossbar member 250 connects or extends into the crossbar member end 224 of the angled portion 220 of the respective support leg member 210. The crossbar member 250 may further comprise a crossbar gripping element 254 similar in construction and configuration as the at least one support leg member gripping element 230. The crossbar gripping element 254 may be a padded roll or molded rubber or plastic hand grip disposed around or along the crossbar member 250.

As illustrated in FIGS. 7 and 8, each mounting plate 232 comprises a support leg member connection 234. Each mounting plate 232 may further comprise a pair of mounting holes 238. Each mounting plate 232 is attached to the respective support leg member 210 at an opposing end 216 of the respective support leg member 210. The support leg member connection 234 may comprise a mounting plate articulating joint 236. The mounting plate articulating joint 236 allows the vertical portion 212 of the respective support leg member 210 to attach to and adjust in angle with respect to the mounting plate 232. Once the angle is adjusted, a securing element, such as a pin, screw, rod, or the like, may engage the mounting plate articulating joint 236 to keep it fixed in position. Each of the mounting plates 232 is attachable to a mower platform 20 of the riding lawnmower 10. Each of the mounting plates 232 is attachable via a plurality of mechanical fasteners, such as bolts, rivets, screws, or the like engaging the pair of mounting holes 238, or by welds.

It is contemplated that the support apparatus 100 and 200 constructed in accordance with the present invention will be tailored and adjusted by those of ordinary skill in the art to accommodate various levels of performance demand imparted during actual use. Accordingly, while this invention has been described by reference to certain specific embodiments and examples, it will be understood that this invention is capable of further modifications. This application is, therefore, intended to cover any variations, uses or adaptations of the invention following the general principles thereof, and including such departures from the present disclosure as come within known or customary practice in the art to which this invention pertains and fall within the limits of the appended claims.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A support apparatus for use with a riding lawnmower comprising:
a pair of support leg members;
a crossbar member connecting the pair of support leg members at one end of each of the support leg members; and
a pair of mounting plates, each mounting plate attached to one of the support leg members at an opposing end of each of the support leg members.

2. The support apparatus of claim 1, wherein each of the mounting plates are attachable to a mower platform of the riding lawnmower.

3. The support apparatus of claim 1, wherein each of the pair of support leg members comprise a bend.

4. The support apparatus of claim 1, wherein each of the pair of support leg members comprise a vertical portion and an angled portion extending from the vertical portion.

5. The support apparatus of claim 4, wherein the crossbar member connects the pair of support leg members at the angled portion.

6. The support apparatus of claim 4, wherein each mounting plate is attached to one of the support leg members at the vertical portion.

7. The support apparatus of claim 4, wherein the angled portion extends from the vertical portion at a bend.

8. The support apparatus of claim 1, wherein each of the support leg members extends perpendicularly from the respective mounting plate.

9. The support apparatus of claim 1, wherein each of the support leg members comprise at least one support leg member gripping element.

10. The support apparatus of claim 1, wherein the crossbar member comprises a crossbar gripping element.

11. A support apparatus for use with a riding lawn mower comprising:
a pair of support leg members, each support leg member comprising a vertical portion and an angled portion extending from the vertical portion at a bend;
a crossbar member connecting the pair of support leg members at one end of the angled portion of each of the support leg members; and
a pair of mounting plates, each mounting plate attached to one of the support leg members at one end of the vertical portion of the respective support leg member.

12. The support apparatus of claim 11, wherein each mounting plate comprises a pair of mounting holes.

13. The support apparatus of claim 11, wherein each vertical portion of the support leg members extends perpendicularly from the respective mounting plate.

14. The support apparatus of claim 11, wherein each support leg member further comprises at least one support leg member gripping element.

15. The support apparatus of claim 11, wherein the crossbar member comprises a crossbar gripping element.

16. The support apparatus of claim 15, wherein the crossbar gripping element is a padded hand grip.

17. A support apparatus for use with a riding lawn mower comprising:
a pair of support leg members, each support leg member comprising a vertical portion and an angled portion connected to the vertical portion by an articulating joint;
a crossbar member connecting the pair of support leg members at one end of the angled portion of each of the support leg members; and
a pair of mounting plates, each mounting plate attached to one of the support leg members at one end of the vertical portion of the respective support leg member.

18. The support apparatus of claim 18, wherein each mounting plate is attached to the respective vertical portion at a mounting plate articulating joint.

19. The support apparatus of claim 18, wherein each vertical portion of each support leg member comprises a telescoping portion.

20. The support apparatus of claim 18, wherein the crossbar member comprises a crossbar gripping element.
